(19) United States
(12) Patent Application Publication
(10) Pub. No.: US 2008/0034773 A1
(43) Pub. Date: Feb. 14, 2008

(54) SYSTEM AND METHOD FOR AUTOMATIC CONTROL OF CATERING TRUCK REFRIGERATION

(76) Inventor: Vahe Karapetian, Los Angeles, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/464,445

(22) Filed: Aug. 14, 2006

(51) Int. Cl. F25B 27/00; B60H 1/32

(52) U.S. Cl. 62/236; 62/239

(57) ABSTRACT

A system for maintaining a selected temperature in a refrigeration unit of a food service vehicle includes a control box which manages operation of refrigeration compressors in one of multiple operating states such that they are constantly supplied with power which enables the refrigeration unit to maintain the selected temperature. The default or first operating state exists when a battery supplies electrical power to the compressors. The second operating state exists when an engine supplies mechanical power to the compressor. The third operating state exists when external power source supplies electrical power to the compressor. The control box automatically switches the system from one state to another in order to maintain the constant supply of power.

### BACKGROUND OF THE INVENTION

This invention relates to the automatic control of refrigeration units associated with catering trucks.

Catering trucks are kitchens on wheels. Apart from cooking equipment and accessories, a catering truck kitchen is equipped with a refrigeration unit—typically two refrigeration units. One refrigeration unit is for storage and is normally located beneath a refrigerated food dressing table. The other refrigeration unit is normally located on the side of the catering truck where refrigerated food is displayed to customers.

A typical catering truck starts its daily route early in the morning, often between 5:30 a.m. and 6:00 a.m. The truck drives around serving breakfast, mid-morning breaks, and lunches at various locations. Some catering trucks also serve mid-afternoon breaks. A typical catering truck will return to its depot at around 2:30 p.m. Therefore, a typical catering truck is on the road moving from stop to stop on its route for approximately 8½ hours. Some catering trucks that serve dinners and suppers have different hours of operation but still typically operate about six to eight hours a day.

A catering truck depot is a place where catering trucks are cleaned and parked when not on their routes. The depot provides the catering truck operators with the facilities and utilities to clean their trucks, charge their batteries and freeze their refrigerators' cold holding plates. The depot also provides the operators with ice for chilling beverages and a commissary where the operators can purchase most of their food, beverages and supplies.

Federal standards require that commercial refrigeration units maintain a temperature of 41° F. or below at all times, 24 hours a day. Refrigeration units in typical catering trucks are equipped with cold holding plates to cool the units. After the day's route, the catering trucks are returned and cleaned at the depot. The refrigeration unit is plugged into an electric main overnight and the cold holding plates are freezed for the next day's use. The holding plates do not have temperature controls and a significant amount of electricity is normally lost since the compressor will run all night until the operator returns the next morning and switches off the compressor. Some catering trucks are equipped with generators or truck engine-powered compressors to assist in the cooling.

The current systems used in catering trucks have a high degree of failure in meeting Federal standards. In most cases, the cold holding plates are not capable of maintaining the refrigeration temperature constantly at the Federal Standard, presently 41° F. or below, for a full service day. Even systems with onboard generators are not reliable because the generators can fail due to poor maintenance or the operator refusing to use the generator to save on fuel or avoid generator noise and fumes. Operators with truck engine-powered compressors are also reluctant to run their truck engine continuously because of the cost, noise and fumes. However, failure to refrigerate food at or below the Federal Standard temperature is a public health hazard.

Accordingly, there is a need for a system that can reliably maintain the temperature of a refrigeration unit at or below the Federal Standard temperature, at all times, independent of operator intervention. Preferably, such a system ensures that there is an uninterrupted source of power to the refrigeration unit to maintain the desired temperature. The present invention fulfills these needs and provides other related advantages.

### SUMMARY OF THE INVENTION

The present invention is directed to a system for maintaining a selected temperature in a refrigeration unit of a food service vehicle. The system comprises a battery or series of batteries associated with the food service vehicle. The battery is electrically connected to a compressor for the refrigeration unit and maintains power to the refrigeration unit in a default first operating state of the system. When an engine associated with the food service vehicle is started, power to the refrigeration unit will be automatically switched to a second operating state wherein the compressor is powered by mechanical force transferred from the engine by means of a belt or other drive mechanism connected to the compressor. In an alternative embodiment, a generator, i.e., an alternator in the engine, is electrically connected to the compressor and supplies electromechanical power. Power to the refrigeration unit will be automatically switched from either the first or the second operating states to a third operating state when a power source, i.e., a local power grid, external to the food service vehicle is electrically connected to the compressor.

Power to the refrigeration unit will be automatically switched from the third operating state back to either the first or second operating state when the power source external to the food service vehicle is no longer electrically connected to the compressor. Moreover, power to the refrigeration unit will be automatically switched from the second operating state back to the first operating state when the engine is no longer running. The battery or batteries may be charged in either the second or third operating state.

In the preferred embodiment, the refrigeration unit includes first and second refrigerators, both connected to the compressor. Further, the compressor comprises first and second compressors both connected to one or more refrigeration units. Where two compressors are present, the first compressor operates on electrical power supplied in either the first or the third operating states and the second compressor operates on mechanical power supplied in the second operating state. Alternatively, the second compressor may operate on electrical power supplied by a generator in the second operating state.

The refrigeration unit is constantly maintained at the selected temperature through the automatic switching of power sources to the refrigeration unit. The automatic switching is accomplished by an automatic control box connected to the compressor.

The present invention is also directed to a process for continuously operating the food service vehicle refrigeration unit in one of the three operating states to maintain a selected temperature in the refrigeration unit. The inventive process comprises the steps of operating the refrigeration unit in the first operating state when the engine is shut off and no external power is provided to the food service vehicle; switching the refrigeration unit automatically from the first operating state to the second operating state when the engine associated with the food service vehicle is running; and switching the refrigeration unit automatically from the first or second operating states to the third operating state when the external power source is connected to the food service vehicle.

The process further comprises the steps of switching the refrigeration unit automatically from the third operating state back to either the first or second operating states when the external power source is disconnected from the food service vehicle; and switching the refrigeration unit automatically from the second operating state back to the first operating state when the engine associated with the food service vehicle is turned off.

The process of switching between the first and second operating states continues until the external power source is connected to the food service vehicle and the refrigeration unit is switched to the third operating state.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a block schematic diagram of the system of the present invention; and

FIG. 2 is an electrical schematic diagram of the system of the present invention.

### DETAILED DESCRIPTION OF THE PREFERRED EMBODIMENTS

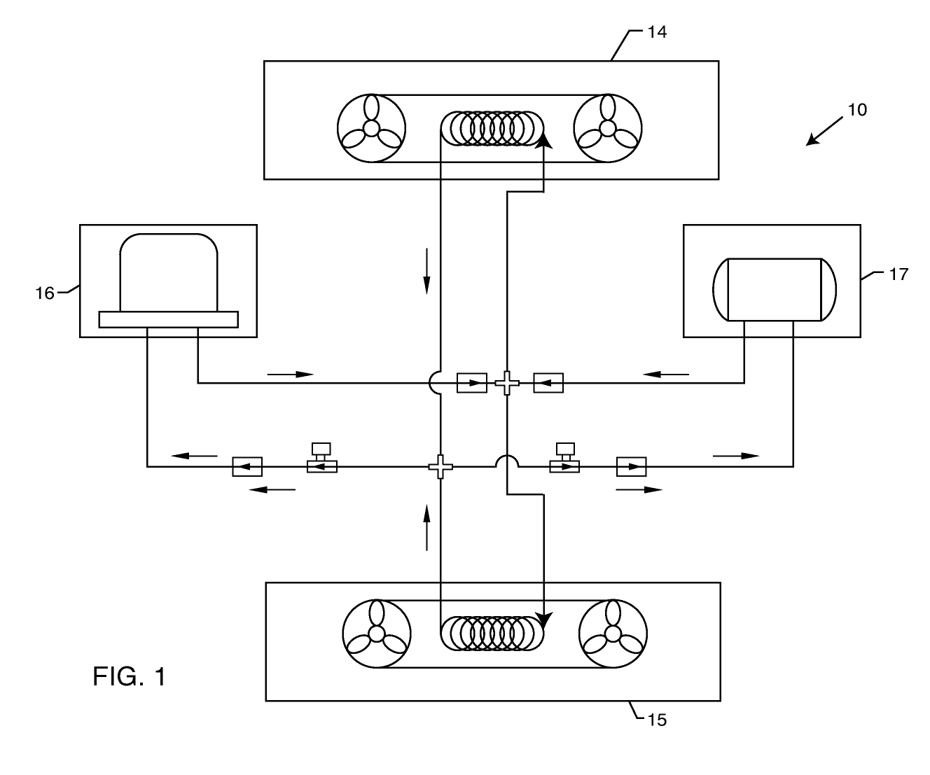

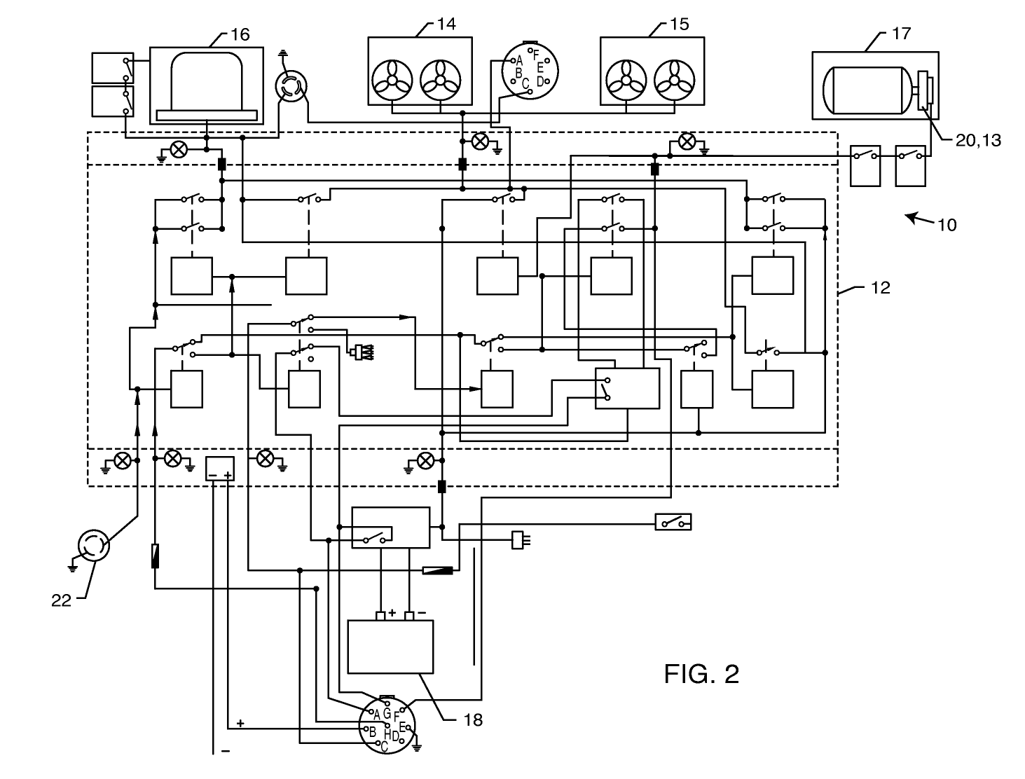

The present invention is directed to a system for maintaining a temperature in a refrigeration unit of a food service vehicle. The system 10 is shown diagrammatically in FIG. 1 and schematically in FIG. 2. As shown, a control box 12 enables a compressor 16 in a refrigeration unit 14 to operate as needed to maintain a selected temperature. The compressor 16 is powered by electrical, mechanical or electromechanical power as described more fully below. The control box 12 manages the supply of power to the compressor 16 so that there will be a continuous supply of power to the compressor 16 to maintain the selected temperature in the refrigeration unit 14.

The control box 12 manages the system 10 such that it is always operating in one of three operating states. The first or default operating state exists when the compressor 16 is run on electrical power supplied by a battery 18, preferably 24 volts, associated with the system 10. The system 10 may include a series of batteries 18. An inverter is needed between the battery 18 and the compressor 16. The second operating state exists when the compressor 16 is run on mechanical power. Mechanical power may either turn the compressor 16 directly through a belt or other means to connect the compressor 16 to the main shaft of an engine associated with the food service vehicle. Alternatively, mechanical power may be converted to electrical power as in a generator 20 associated with the food service vehicle. The generator 20 may take the form of an alternator or other power generating system associated with the motor vehicle engine. The third operating state exists when the system 10 is connected to an external power source 22 and the compressor 16 is run on electrical power supplied therefrom.

The system 10 may include first and second refrigeration units 14, 15 as well as first and second compressors 16, 17. Where two refrigeration units 14, 15 are present both are powered by the compressor 16. Where two compressors 16, 17 are present both are capable of powering the refrigeration unit 14. Where two refrigeration units 14, 15 and two compressors 16, 17 are present each compressor 16, 17 is capable of running both refrigeration units 14, 15. In a system with two compressors 16, 17, the first compressor 16 is preferably configured to run on electrical power supplied by either an external power source or a battery. The second compressor 17 is preferably configured to run on mechanical power supplied by a connection to the main shaft of the motor vehicle engine, as in a belt or other method of transferring mechanical power from the engine to the compressor. Such compressors are typically called overroad compressors.

The advantage of the control box 12 is that the management of power to the compressors 16, 17 is automatic depending on which operating state the system 10 is in. When the food service vehicle is parked at the depot and plugged into an electrical main 22, the refrigeration units 14, 15 are coded by the compressor 16 that derives its power from the electrical main 22. At the same time, the batteries 18 are charged for later use. When the food service vehicle is unplugged from the electrical main 22 and the engine 13 turned on, the control box 12 automatically switches the refrigeration units 14, 15 to the overroad compressor 17 that is powered by the engine 13. When the food service vehicle stops at a route stop and the engine 13 is switched off, the control box 12 automatically switches the refrigeration units 14, 15 to the compressor 16 powered by the series of batteries 18. When the operator starts the engine 13 to move on to the next route stop, the control box 12 automatically switches from the compressor 16 operating on battery 18 power to the overroad compressor 17 operating on mechanical power. The automatic switching back and forth between the compressor 16 powered by batteries 18 and the overroad compressor 17 will continue until the truck returns to the depot and the system 10 is plugged into the electrical main 22. Once plugged in, the control box 12 automatically switches the system 10 to the compressor 16 and powers it with electricity from the electrical main 22, as described above.

In operation, the process provides a reliable means to maintain a constant power supply to the compressors 16, 17 through automation, thereby maintaining the selected temperature in the refrigeration units 14, 15. An operator will pick up his/her food service vehicle at the depot at the start of a shift. At this time the refrigeration units 14, 15 are sufficiently cool and the batteries 18 on the food service vehicle are fully charged.

After the operator disconnects the electrical main 22, the batteries 18 are supplying power to the first compressor 16 thus maintaining the temperature in the refrigeration units 14, 15. When the operator starts the engine of the food service vehicle, the control box 12 automatically switches the supply of power from the batteries 18 to the engine 1, powering the second compressor 17. Alternatively, the control box 12 automatically switches from the first compressor 16 powered by the batteries 18 to the second compressor 17 powered by the generator 20 in the food service vehicle. The generator 20 may also recharge the batteries 18 associated with the food service vehicle.

When the operator reaches a route stop and switches off the engine, the control box 12 automatically switches the supply of power back to the batteries 18 to operate the first compressor 16. While at the route stop, the batteries 18 power the first compressor 16 thus maintaining the desired temperature in the refrigeration units 14, 15. When the operator leaves the route stop, the engine is started thus switching the power supply back to the engine 13 and repeating the operating state described above. This cycle repeats for each route stop that the operator makes.

At the end of a shift, the operator returns the food service vehicle to the depot and connects the system 10 to the external power source 22. This local power grid 22 supplies the power to the first compressor 16 to maintain the temperature in the refrigeration units 14, 15. During this time the batteries 18 are also charged. The food service vehicle remains connected to the external power source 22 until the operator takes the vehicle out for another shift.

In a preferred embodiment, the compressors 16, 17 may be dedicated to operate during only specific of the above described operating states. The first compressor 16 is an electrical compressor configured to operate only during the first and third operating states, i.e., when the batteries 18 or electrical main 22 are supplying power to the system 10. In either of these states the first compressor 16 maintains the temperature in both refrigeration units 14, 15. The second or overroad compressor 17 is designed to operate only during the second operating state, i.e., when the food service vehicle engine is running and supplying mechanical power to the second compressor 17. In this state, the second compressor 17 receives mechanical power from the engine 13 and maintains the temperature in both refrigeration units 14, 15.

In any embodiment, the refrigeration units 14, 15 have temperature control mechanisms (not shown) to automatically switch the compressors 16, 17 on or off depending upon whether the temperature in the refrigeration units 14, 15 is above or below the selected temperature.

Evaporator fans (not shown) in the refrigeration units 14, 15 are powered by the external power source 22 when the system 10 is operating in the third operating state. Once the external power source 22 is disconnected from the system 10, the evaporator fans are powered by the batteries 18. The evaporator fans are powered by the batteries 18 regardless of whether the engine 13 is supplying power to the system 10. The batteries 18 will continue to power the evaporator fans until the system 10 is reconnected to the external power source 22.

The principal advantage and uniqueness of the control box 12 is that its operation is automatic and requires no human intervention. Other significant advantages include:

It enables catering trucks to maintain temperatures of 41° F. or below temperature on a continuous basis for its refrigerators, which is in compliance with Federal standards;

It reduces a public health risk since refrigerators are kept at the temperature mandated by Federal standards;

It saves energy and fuel since renewable energies are used during route stops and temperature is automatically monitored and controlled—overnight energy savings alone is estimated to be at least 50 percent;

There is also significant savings for vehicles that operate generators or keep their vehicle engines running at route stops to power their vehicles' refrigeration compressors;

It reduces pollution since it eliminates the use of generators and the practice of leaving the truck engine running when the catering trucks are at their route stops;

The dressing table area and food and meat storage refrigeration are maintained within NSF and Federal standards, and Health Department regulations without human intervention and the possibility of human error and oversight.

It includes a temperature control mechanism which will shut down the compressors when the selected temperature is achieved and restart the compressors when the temperature rises above the selected temperature.

Although several embodiments of the invention have been described in detail for purposes of illustration, various modifications may be without departing from the spirit and scope of the invention.

What is claimed is:

1. A system for maintaining a selected temperature in a refrigeration unit of a food service vehicle, comprising:
a battery associated with the food service vehicle, electrically connected to a compressor for the refrigeration unit to maintain power to the refrigeration unit in a system default, first operating state;
means for automatically switching power to the refrigeration unit from the battery to an engine associated with the food service vehicle and mechanically connected to the compressor when the system is in a second operating state wherein the engine is running and supplying power to the refrigeration unit; and
means for automatically switching power to the refrigeration unit from either the first or the second operating states to a third operating state wherein a power source external to the food service vehicle and electrically connected to the compressor maintains power to the refrigeration unit.

2. The system of claim 1, comprising means for automatically switching power to the refrigeration unit from the third operating state back to either the first or second operating states when the power source external to the food service vehicle is no longer electrically connected to the compressor.

3. The system of claim 1, comprising means for automatically switching power to the refrigeration unit from the second operating state back to the first operating state when the engine associated with the food service vehicle is no longer running.

4. The system of claim 1, wherein the refrigeration unit comprises first and second refrigeration units.

5. The system of claim 1, wherein the compressor comprises first and second compressors connected to the refrigeration unit.

6. The system of claim 5, wherein the first compressor operates on electrical power supplied in either the first or the third operating states and the second compressor operates on mechanical power supplied in the second operating state.

7. The system of claim 1, wherein the external power source is a local power grid connected through a standard outlet.

8. The system of claim 1, wherein a generator associated with the food service vehicle is powered by the engine for the food service vehicle.

9. The system of claim 1, wherein the battery comprises a series of batteries.

10. The system of claim 1, wherein the selected temperature in the refrigeration unit is constantly maintained through the automatic switching of power to the refrigeration unit.

11. The system of claim 1, wherein during the second and third operating states, the battery is charged.

12. The system of claim 1, wherein the power switching means comprises a control box connected to the compressor.

13. A system for maintaining a selected temperature in a refrigeration unit of a food service vehicle, comprising:
a battery associated with the food service vehicle, electrically connected to a compressor for the refrigeration unit to maintain power to the refrigeration unit in a system default, first operating state;
a control box connected to the compressor;
wherein the control box automatically switches power to the refrigeration unit from the first operating state to a second operating state wherein an engine associated with the food service vehicle and mechanically connected to the compressor supplies power to the refrigeration unit;
wherein the control box automatically switches power to the refrigeration unit from either the first or the second operating states to a third operating state wherein a power source external to the food service vehicle and electrically connected to the compressor supplies power to the refrigeration unit;
wherein the control box automatically switches power to the refrigeration unit from the third operating state back to either the first or second operating states when the power source external to the food service vehicle is no longer electrically connected to the compressor;
wherein the control box automatically switches power to the refrigeration unit from the second operating state back to the first operating state when the engine associated with the food service vehicle is no longer running;
wherein during the second or the third operating states, the battery is charged; and
wherein the selected temperature in the refrigeration unit is constantly maintained through the automatic switching of power to the refrigeration unit.

14. The system of claim 13, wherein the refrigeration unit comprises first and second refrigerators.

15. The system of claim 13, wherein the compressor comprises first and second compressors connected to the refrigeration unit, and wherein the first compressor operates on electrical power supplied in either the first or the third operating states and the second compressor operates on mechanical power supplied in the second operating state.

16. The system of claim 13, wherein the external power source is a local power grid connected through a standard outlet, and wherein a generator associated with the food service vehicle is powered by a motor vehicle engine for the food service vehicle and supplies power to the second compressor.

17. A process for continuously operating a food service vehicle refrigeration unit in one of three operating states to maintain a selected temperature in the refrigeration unit, wherein a default or first operating state exists when a battery associated with the food service vehicle provides power to a compressor for the refrigeration unit, a second operating state exists when an engine associated with the food service vehicle provides mechanical power to the compressor, and wherein a third operating state exists when a power source external to the food service vehicle provides power to the compressor, the process comprising the steps of:
operating the refrigeration unit in the first operating state when the engine is turned off and no external power is provided to the food service vehicle;
switching the refrigeration unit automatically from the first operating state to the second operating state when the engine associated with the food service vehicle is running; and
switching the refrigeration unit automatically from the first or second operating states to the third operating state when the external power source is connected to the food service vehicle.

18. The process of claim 17, further comprising the step of switching the refrigeration unit automatically from the third operating state back to either the first or second operating states when the external power source is disconnected from the food service vehicle.

19. The system of claim 17, further comprising the step of switching the refrigeration unit automatically from the second operating state back to the first operating state when the engine associated with the food service vehicle is turned off.

20. The process of claim 17, further comprising the step of charging the battery when the refrigeration unit is in the second or third operating states.
